(19) United States
(12) Patent Application Publication
(10) Pub. No.: US 2026/0121265 A1
(43) Pub. Date: Apr. 30, 2026

(54) APPARATUS AND METHOD FOR MANUFACTURING SECONDARY BATTERY WITH IMPROVED ELECTROLYTIC IMPREGNATION

(71) Applicant: SAMSUNG SDI CO., LTD., Yongin-si (KR)

(72) Inventors: Donghyun KIM, Yongin-si (KR); Sang Gyu KIM, Yongin-si (KR); Yejin SEO, Yongin-si (KR); Eunjeong MOON, Yongin-si (KR)

(21) Appl. No.: 19/284,987

(22) Filed: Jul. 30, 2025

(30) Foreign Application Priority Data
Oct. 24, 2024 (KR) 10-2024-0146942

(51) Int. Cl. H01M 50/609; H01M 4/04; H01M 10/04

(52) U.S. Cl. CPC H01M 50/609; H01M 4/0447; H01M 10/0404; H01M 10/0481

(57) ABSTRACT

A method of manufacturing a secondary battery includes initially injecting an electrolyte into an internal space of a housing in which an electrode assembly is accommodated, extracting the electrolyte initially injected into the internal space of the housing to an outside of the housing, reinjecting the electrolyte into the internal space of the housing, and applying power to the electrode assembly to charge the electrode assembly after reinjecting the electrolyte.

### CROSS-REFERENCE TO RELATED APPLICATION

The present application claims priority to and the benefit of Korean Patent Application No. 10-2024-0146942, filed on Oct. 24, 2024, in the Korean Intellectual Property Office, the entire disclosure of which is incorporated herein by reference.

### BACKGROUND

### 1. Field

Embodiments relate to an apparatus and method for manufacturing a secondary battery with improved electrolytic impregnation.

### 2. Description of the Related Art

Unlike primary batteries that cannot be charged, secondary batteries are batteries that can be charged and discharged. Generally, a secondary battery includes an electrode assembly including a positive electrode plate, a negative electrode plate, and a separator, and an exterior material (battery can or case) for accommodating the electrode assembly. The electrode assembly may be classified as a wound type electrode assembly and a stacked type electrode assembly according to stacking of the electrode plates and the separator. A wound type is referred to as a jellyroll type electrode assembly and a stack type is referred to as a stacked type electrode assembly. In addition, secondary batteries may be classified as pouch-type, cylindrical, and prismatic type secondary batteries according to a material and a shape of an exterior material.

The above information disclosed in this Background section is for enhancement of understanding of the background of the present disclosure, and therefore, it may contain information that does not constitute a related (or prior) art.

### SUMMARY

Embodiments include a method of manufacturing a secondary battery, the method including initially injecting an electrolyte into an internal space of a housing in which an electrode assembly is accommodated, extracting the electrolyte initially injected into the internal space of the housing to an outside of the housing, reinjecting the electrolyte into the internal space of the housing, and applying power to the electrode assembly to charge the electrode assembly after reinjecting the electrolyte.

The housing may be elastically deformable, and the method may further include, while reinjecting the electrolyte, repeatedly pressurizing the housing to allow the electrode assembly inside the housing to be repeatedly compressed and restored.

The initially injecting may include injecting a portion of a maximum volume of the electrolyte, the method may further include, after applying power to the electrode assembly, additionally injecting the electrolyte into the housing.

The method may further include applying heat to the housing while repeatedly pressurizing the housing.

Applying a vibration to the housing may be performed while repeatedly pressurizing the housing.

The method may further include, after applying power to the electrode assembly, injecting the electrolyte into the housing.

The method may further include, after initially injecting the electrolyte, connecting a flow unit configured to inject the electrolyte into the housing and extract the electrolyte from the housing.

The flow unit may include a pumping module in which a pump is embedded, a first tube connected to a first side of the pumping module, and a second tube connected to a second side of the pumping module, the first tube and the second tube being connected to the housing, and initially injecting the electrolyte may include operating the pump so that the electrolyte inside the housing passes through the first tube, the pump, and the second tube and returns to the housing.

Embodiments include an apparatus for manufacturing a secondary battery, including a flow unit configured to discharge an electrolyte to an outside of a housing, resulting in a discharged electrolyte, and guide the discharged electrolyte back into the housing while connected to the housing of a secondary battery in which an electrode assembly and the electrolyte are accommodated, wherein the flow unit includes a pumping module in which a pump is embedded, a first tube connected to a first side of the pumping module, and a second tube connected to a second side of the pumping module and connected to the housing to discharge the electrolyte.

The housing may include a first electrolyte inlet and a second electrolyte inlet, and the first tube may be connected to the first electrolyte inlet, and the second tube may be connected to the second electrolyte inlet.

The pumping module may include a pressure sensor configured to detect a pressure of the electrolyte introduced into the housing, and a flow rate sensor configured to detect a flow rate of a pumped electrolyte.

The pumping module may further include an input/output part configured to output detected results of the pressure sensor and the flow rate sensor.

The housing may be elastically deformable, and the apparatus may further include a plurality of pressurization units configured to repeatedly pressurize the housing while the electrolyte flows by the flow unit to allow the electrode assembly within the housing to be repeatedly compressed and restored.

Each of the plurality of pressurization units includes a pressurization body configured to come into surface contact with the housing and push modules configured to repeatedly pressurize each pressurization body toward the housing.

A plurality of the pressurization body may include two pressurization bodies, the two pressurization bodies being on opposite sides of the housing.

A total area of the two pressurization bodies facing the housing may be greater than or equal to a close contact area between the two pressurization bodies and the housing.

Cover plates may be mounted on opposite surfaces of the two pressurization bodies.

A heating part configured to heat the two pressurization bodies is in each of the two pressurization bodies.

The apparatus may further include a temperature controller configured to control a heating temperature of each heating part.

A vibration generator configured to apply vibration energy to each pressurization body may be further installed in each pressurization body.

### BRIEF DESCRIPTION OF THE DRAWINGS

Features will become apparent to those of ordinary skill in the art by describing in detail exemplary embodiments with reference to the attached drawings, in which:

FIGS. 1 and 2 are perspective views illustrating an electrode assembly that may be embedded in a secondary battery manufactured by an apparatus for manufacturing a secondary battery according to an embodiment of the present disclosure;

FIG. 3 is a perspective view illustrating a prismatic secondary battery manufactured by the apparatus for manufacturing a secondary battery according to an embodiment of the present disclosure;

FIG. 4 is a diagram illustrating another example of the prismatic square secondary battery manufactured by the manufacturing apparatus according to an embodiment of the present disclosure;

FIGS. 5 and 6 are exploded perspective views illustrating the secondary battery shown in FIG. 4;

FIG. 7 is a flowchart illustrating a method of manufacturing a secondary battery according to an embodiment of the present disclosure;

FIGS. 8A to 8G are schematic diagrams illustrating the method of manufacturing a secondary battery according to an embodiment of the present disclosure;

FIGS. 9 and 10 are diagrams illustrating a state in which an electrode assembly is repeatedly pressurized using the apparatus for manufacturing a secondary battery according to an embodiment of the present disclosure;

FIG. 11 is a flowchart for describing a modified example of the method of manufacturing a secondary battery according to an embodiment of the present disclosure;

FIG. 12 is a flowchart illustrating another modified example of the method of manufacturing a secondary battery according to an embodiment of the present disclosure;

FIG. 13 is a diagram separately illustrating a flow unit of the apparatus for manufacturing a secondary battery according to an embodiment of the present disclosure;

FIGS. 14 to 16 are diagrams for describing various types of modified examples of the pressurization unit of the apparatus for manufacturing a secondary battery according to an embodiment of the present disclosure;

FIG. 17 is an exemplary diagram illustrating a secondary battery module, in which secondary batteries are disposed, manufactured by a manufacturing method according to an embodiment of the present disclosure;

FIG. 18 is an exemplary diagram illustrating a secondary battery pack formed to apply the secondary battery module shown in FIG. 17 to a product; and

FIG. 19 is a diagram illustrating a vehicle in which the secondary battery pack shown in FIG. 18 is embedded.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her embodiments in the best way. The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements.

References to two compared elements, features, etc. as being “the same” may mean that they are “substantially the same.” Thus, the phrase “substantially the same” may include a case having a deviation that is considered low in the art, for example, a deviation of 5% or less. In addition, uniformity of a parameter in a predetermined region may imply uniformity from an average perspective.

Although the terms first, second, and the like are used to describe various components, these components are substantially not limited by these terms. These terms are only used for distinguishing one component from another component, and unless otherwise stated, it is of course that a first component may also be a second component.

Throughout the specification, unless otherwise stated, each element may be singular or plural.

Arranging an arbitrary element “above (or below)” or “on (under)” another element may mean that the arbitrary element may contact the upper (or lower) surface of the element and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list.

Throughout the specification, if “A and/or B” is stated, it means A, B or A and B, unless otherwise stated and if “C to D” is stated, it means C or more and D or less, unless otherwise stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

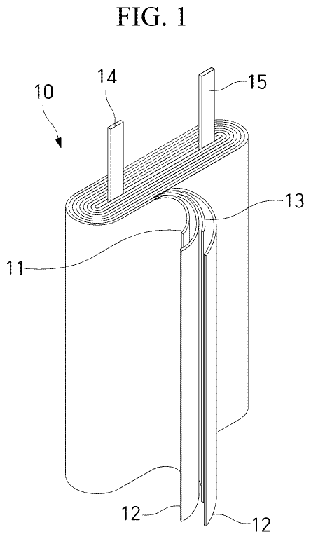

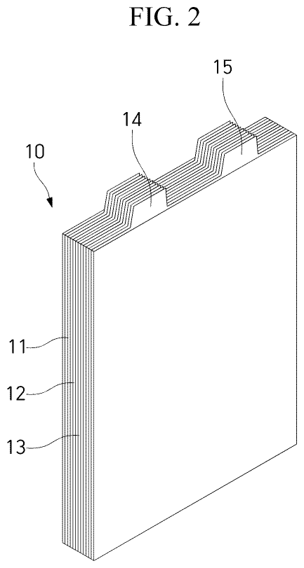

FIGS. 1 and 2 are perspective views illustrating an electrode assembly that may be embedded in a secondary battery manufactured by an apparatus for manufacturing a secondary battery according to an embodiment of the present disclosure. FIG. 1 shows a wound type electrode assembly, and FIG. 2 shows a stacked type electrode assembly.

An electrode assembly 10 may be formed by winding or stacking a stack of a first electrode plate 11, a separator 12, and a second electrode plate 13, each of which are formed as thin plates or films. When the electrode assembly 10 is a wound stack, a winding axis may be parallel to the longitudinal direction of a case. In other embodiments, the electrode assembly 10 may be a stack type rather than a winding type, and the shape of the electrode assembly 10 may vary. In addition, the electrode assembly 10 may be a Z-stack electrode assembly in which a positive electrode plate and a negative electrode plate are inserted into both sides (e.g., opposite sides) of a separator, which is then bent (or folded) into a Z-stack.

The first electrode plate 11 of the electrode assembly 10 may act as a negative electrode, and the second electrode plate 13 may act as a positive electrode. Of course, the reverse is also possible.

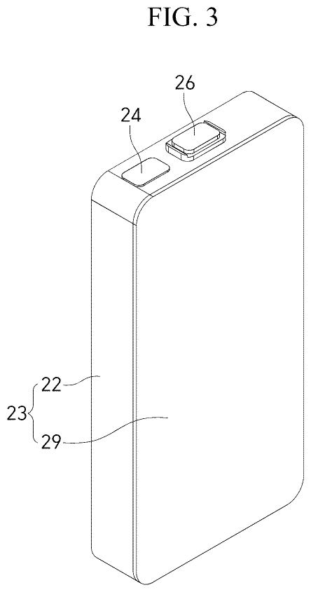

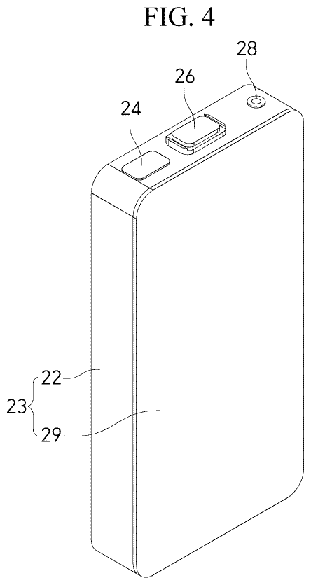

The first electrode plate 11 may be formed by applying (e.g., coating or depositing) a first electrode active material, such as graphite or carbon, onto a first electrode substrate formed of a metal foil, such as copper, a copper alloy, nickel, or a nickel alloy. The first electrode plate 11 may include a first electrode tab 14 (e.g., a first uncoated portion), which is a region to which the first electrode active material is not applied. The first electrode tab 14 may be connected to an external first terminal (see FIGS. 3 and 4). In some embodiments, when the first electrode plate 11 is manufactured, the first electrode tab 14 may be formed by being cut in advance to protrude to (or protrude from) one side of the electrode assembly 10, or the first electrode tab 14 may protrude to one side of the electrode assembly 10 more than (e.g., farther than or beyond) the separator 12 without being separately cut.

The second electrode plate 13 may be formed by applying (e.g., coating or depositing) a second electrode active material, such as a transition metal oxide, onto a second electrode substrate formed of a metal foil, such as aluminum or an aluminum alloy. The second electrode plate 13 may include a second electrode tab 15 (e.g., a second uncoated portion), which is a region to which the second electrode active material is not applied. The second electrode tab 15 may be connected to an external second terminal (see FIGS. 3 and 4). In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

In some embodiments, the electrode assembly 10 may be accommodated in a case along with an electrolyte. In a pouch-type secondary battery, an electrode assembly 10 may be accommodated in a pouch made of flexible material (see, e.g., FIG. 2). In a cylindrical or prismatic secondary battery, an electrode assembly 10 may be accommodated in a cylindrical or prismatic metal battery can.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium-nickel oxide, a lithium-cobalt oxide, a lithium-manganese oxide, a lithium iron phosphate compound, a cobalt-free nickel-manganese oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}Co_{c}L¹ₐGₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof, and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but other materials are possible.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be silicon, a silicon-carbon composite, SiOₓ (0<x<2), a Si alloy, or a combination thereof.

The silicon-carbon composite may be a composite of silicon and amorphous carbon. According to an embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate, an ester, an ether, a ketone, an alcohol solvent, an aprotic solvent, and may be used alone or in combination of two or more.

In addition, when a carbonate solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but the inorganic material may vary.

The organic material and the inorganic material may be mixed in one coating layer or may be in the form of a coating layer including (or containing) an organic material and a coating layer including (or containing) an inorganic material that are stacked on each other.

FIG. 3 is a perspective view illustrating a prismatic secondary battery manufactured by the apparatus for manufacturing a secondary battery according to an embodiment of the present disclosure, and FIG. 4 is a diagram illustrating another example of the prismatic square secondary battery manufactured by the manufacturing apparatus according to an embodiment of the present disclosure.

A battery can 22 defines an overall appearance of the prismatic secondary battery, and may be made of a conductive metal, such as stainless use steel (or SUS), aluminum, aluminum alloy, or nickel-plated steel. In addition, the battery can 22 may provide a space for accommodating an electrode assembly therein.

The first terminal 24 and the second terminal 26 may be electrically connected to the first electrode tab 14 and the second electrode tab 15 of the electrode assembly 10 accommodated inside the battery can 22, respectively, and may be installed to be exposed to the outside of the battery can 22. In addition, although not illustrated, a vent that opens due to gas generated inside the battery and discharges the gas (degassing) may be formed at any location of the battery can 22.

In the embodiment of FIG. 3, an injection port for injecting electrolyte into the battery can 22 is not formed separately, so that in order to inject electrolyte into the battery can 22, it must be injected in advance before sealing the cover 29. On the other hand, in the embodiment of FIG. 4, an electrolyte inlet 28 is formed in the battery can 22, so that the electrolyte can be injected even after sealing the cover 29.

The cover 29 may be coupled to the battery can 22 while covering the battery can 22 in which the electrode assembly 10 is embedded. In the present description, the result of coupling the cover 29 to the battery can 22 is referred to as a housing 23.

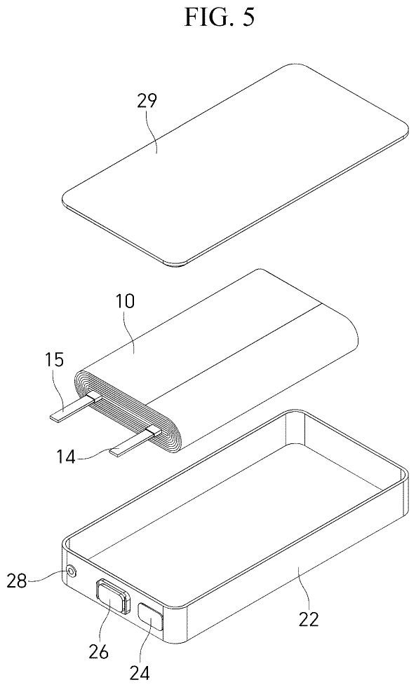

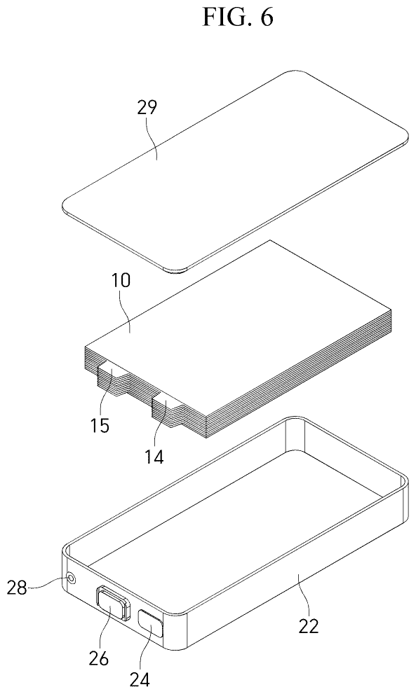

FIGS. 5 and 6 are exploded perspective views illustrating the secondary battery shown in FIG. 4.

The illustrated prismatic secondary battery may have a structure in which a wide transverse surface of the battery can 22 is opened, an electrode assembly 10 is inserted into the opening, and a cover 29 is covered thereon. The first electrode tab 14 and the second electrode tab 15 of the electrode assembly 10 may be connected inside the battery can 22 by welding to the first terminal 24 and the second terminal 26, respectively, exposed to the outside of the battery can 22.

After assembling the electrode assembly 10 and placing the same in the battery can 22 and sealing the cover 29, an electrolyte may be injected through the electrolyte inlet 28, and then subsequent processes such as aging and pre-charging can be performed.

Hereinafter, the state of the secondary battery as shown in FIGS. 3 and 4, that is, the state in which the external terminals 24, 26 are facing upward, is defined as the “upright state.” In addition, the state in which the secondary battery is lying down as shown in FIGS. 5 and 6 is defined as the “laterally placed state.”

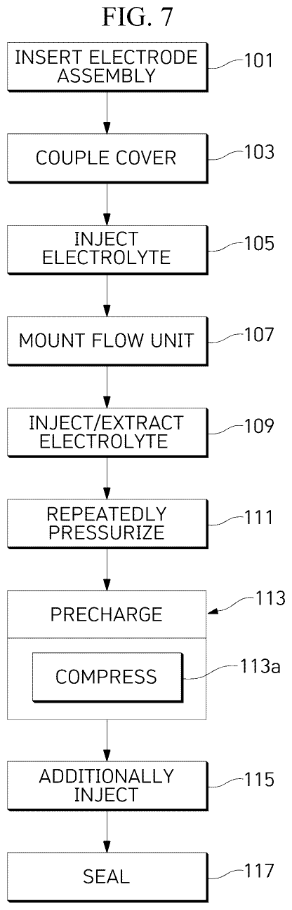

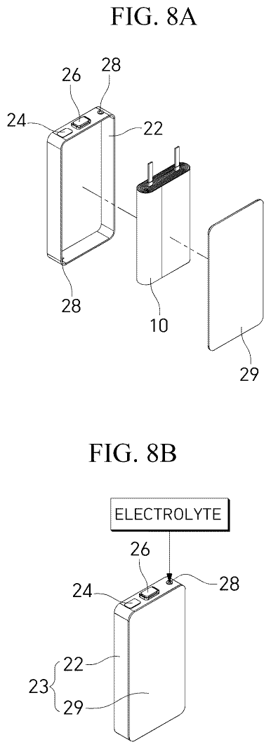

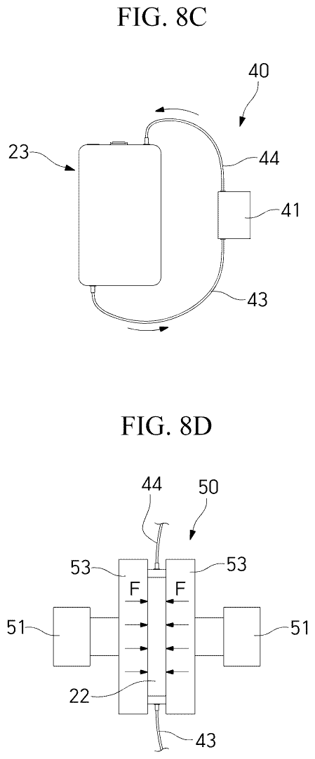

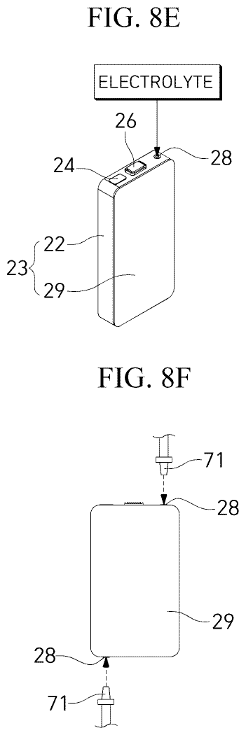

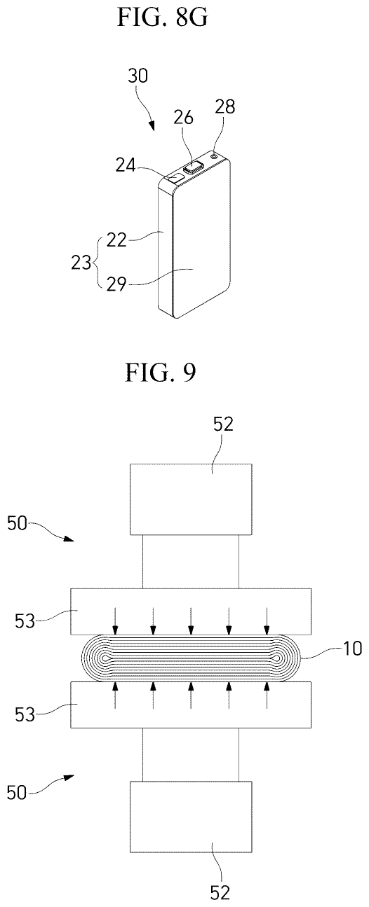

FIG. 7 is a flowchart illustrating a method of manufacturing a secondary battery according to an embodiment of the present disclosure, and FIGS. 8A to 8G are schematic diagrams illustrating the method of manufacturing a secondary battery according to an embodiment of the present disclosure.

As shown in the drawings, the method of manufacturing a secondary battery according to the present embodiment may include an electrode assembly insertion operation 101, a cover coupling operation 103, an electrolyte injection operation 105, a flow unit mounting operation 107, an electrolyte injection/extraction operation 109, a repeated pressurization operation 111, a precharging operation 113, an additional injection operation 115, and a sealing operation 117.

The electrode assembly insertion operation 101 may be a process of mounting the electrode assembly 10 in the prepared battery can 22. The mounted electrode assembly 10 may be a wound type or stacked type electrode assembly. As shown in FIGS. 8A to 8G, the battery can 22 may be opened laterally and may have electrolyte inlets 28 at upper and lower end portions (see FIG. 8F).

The electrolyte inlet 28 may be a passage used to inject an electrolyte into the sealed housing 23. When the electrolyte is injected, only one of the two electrolyte inlets 28 may be used. In other embodiments, the two electrolyte inlets 28 may be utilized to simultaneously inject the electrolyte through the two electrolyte inlets 28. In addition, electrodes of the electrode assembly mounted on the battery can 22 are electrically connected and coupled to terminals 24 and 26.

The cover coupling operation 103 is a process of welding the cover 29 to the battery can 22 after the mounting of the electrode assembly 10 is completed. The coupled body of the battery can 22 and the cover 29 is the housing 23. The housing 23 may provide a sealed internal space. In particular, the housing 23 may be elastically deformed by an external force. For example, as shown in FIGS. 8C to 8D, when forces are applied in directions of arrows F in a thickness direction, the housing 23 may be pressed and elastically thinned. In addition, the housing 23 may be restored to its original state when the pressurizing force is removed.

The electrolyte injection operation 105 is a process of injecting an electrolyte into the internal space of the housing 23 in which the electrode assembly is accommodated. In this case, a volume of the electrolyte being injected may be 60% to 70% of a maximum volume that is injectable into the housing 23.

The subsequent flow unit mounting operation 107 may be a process of mounting a flow unit 40 in the housing 23. That is, after the injection (e.g., the initial injection) of the electrolyte through the electrolyte injection operation 105 is completed, the flow unit 40 is connected to allow the electrolyte to flow in and out of the housing 23. The electrolyte flowing in and out of the housing means that the electrolyte injected into the housing is drawn out of the housing 23 and injected back into the housing 23.

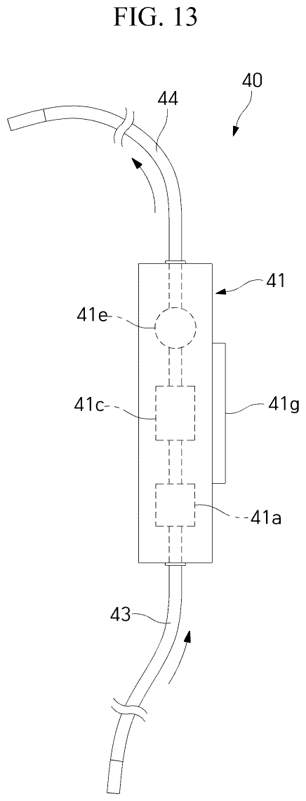

As shown in FIGS. 8A to 8G, the flow unit 40 may include a pumping module 41, a first tube 43, and a second tube 44. As shown in FIG. 13, a pump 41a, a pressure sensor 41c, and a flow rate sensor 41e may be installed inside the pumping module 41. The pump 41a may serve to pump and circulate an electrolyte. In addition, the first tube 43 and the second tube 44 may be connected to both sides (e.g., opposite sides) of the pumping module 41. In FIGS. 8A to 8G, the first tube 43 may be connected to a lower electrolyte inlet 28, and the second tube 44 may be connected to an upper electrolyte inlet 28. The flow unit 40 will be described below.

The electrolyte injection/extraction operation 109 is a process of extracting the electrolyte injected into the housing 23 to the outside of the housing and injecting the electrolyte back into the housing 23. That is, the electrolyte injection/extraction operation 109 may be a process of circulating the electrolyte by operating the pump 41a.

When the pump 41a is operated, the electrolyte inside the housing 23 may be extracted to move to the electrolyte through the first tube 43, and also the electrolyte passing through the pump 41a may be injected into the housing 23 again through the second tube 44. When the pump 41a is operated continuously, the extraction and injection of the electrolyte may continue (e.g., may be continual).

The electrolyte injected into the housing 23 may pass through the inside of the electrode assembly 10 or may be extracted after passing between the electrode assembly 10 and an inner wall surface of the housing 23. In particular, the electrolyte passing through the inside of the electrode assembly 10 passes through a spacing between the stacked body inside the electrode assembly 10 and wets all parts of the electrode assembly. The first and second electrode plates are sufficiently immersed with the electrolyte. Thus, during the precharging operation that is a subsequent process, a solid electrolyte interface (SEI) layer may be smoothly formed. The purpose of the electrolyte injection/extraction operation 109 is to bring the electrode assembly 10 into contact with the electrolyte.

The repeated pressurization operation 111 is a process that can be performed simultaneously while the electrolyte injection/extraction operation is performed. In the repeated pressurization operation 111, the housing 23 may be repeatedly pressurized to allow the electrode assembly 10 inside the housing to be repeatedly compressed and restored. Pressurization units 50 may be used to perform the repeated pressurization operation 111.

The pressurization units 50 are disposed to be opposite to each other with the housing 23 interposed therebetween and repeatedly pressurize the housing 23 in the directions of the arrows F. The housing 23 may receive pressurizing forces of the pressurization units 50 to be compressed in the thickness direction. In addition, the housing 23 may be restored to its original state when the pressurizing forces are removed. When the housing 23 is compressed, the electrode assembly 10 inside the housing 23 may be compressed together with the housing 23.

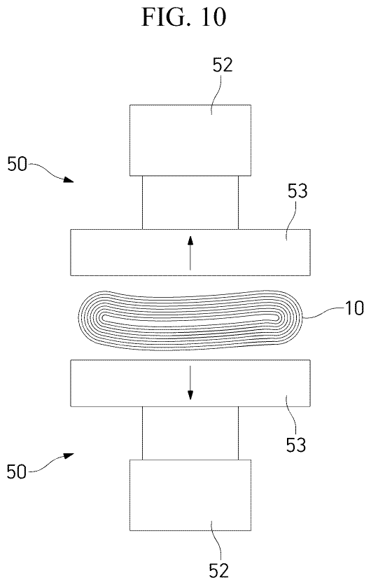

FIGS. 9 and 10 are conceptual diagrams illustrating a state in which the electrode assembly 10 is repeatedly compressed by the pressurization units 50. In the drawings, a wound type electrode assembly is used as the electrode assembly 10 as an example, but the same theory can be applied to a stacked type electrode assembly.

FIG. 9 shows a state in which the electrode assembly 10 is compressed by the pressurizing forces of the pressurization units 50. When the electrode assembly 10 is compressed, the electrolyte accommodated in the spacing inside the electrode assembly may be pressed and spread out, and thus surfaces of the first electrode plate and the second electrode plate may be coated with the electrolyte. Of course, in this case, the excess electrolyte is discharged to the outside of the electrode assembly 10. For reference, the pressurizing forces of the pressurization units 50 do not exceed an elastic deformation range of the electrode assembly 10.

When the forces pressurizing the electrode assembly 10 are removed, the electrode assembly 10 may be restored to its initial state. In this case, since a volume of the spacing inside the electrode assembly increases, a negative pressure may be generated, and the electrolyte outside the electrode assembly 10 may be introduced into the spacing. The electrolyte may be introduced into the electrode assembly due to the negative pressure, and the electrolyte may also be introduced due to capillary action.

When the electrode assembly 10 is pressed again while the electrolyte is introduced into the electrode assembly 10, the electrolyte spreads and thus the first and second electrode plates are coated with the electrolyte as described above. Eventually, as the electrode assembly 10 is repeatedly compressed, all the parts of the electrode assembly 10 may be wet with the electrolyte.

The precharging operation 113 may be a process of applying power to the electrode assembly 10 after the repeated pressurization operation 111 is completed. That is, the precharging operation 113 may be a process of precharging the electrode assembly 10 by supplying a predetermined amount of power to the terminals 24 and 26 provided on an outer side of the battery can 22. Through the precharging operation 113, lithium ions move to a negative electrode and react with the electrolyte, thereby forming a film referred to as an SEI (Solid Electrolyte Interphase) layer on a surface of the negative electrode.

The precharging operation 113 may include a compressing process 113a. The compressing process 113a is a process for increasing a precharging effect and may involve compressing the electrode assembly during the precharging operation to suppress lifting of the spacing inside the electrode plate and to strengthen a bonding force of the electrode plate. When the precharging is performed, problems such as lifting of the electrode plates forming the electrode assembly 10, local charging malfunction due to insufficient adhesion between the electrode plates, and occurrence of side reactions due to the local charging malfunction may occur, and therefore the compressing process 113a may be performed.

The additional injection operation 115 is a process of additionally injecting the electrolyte into the housing after the precharging operation 113 is completed. As described above, since 60% to 70% of the electrolyte is injected in the electrolyte injection operation 105, the remaining 30% to 40% is additionally injected. The two electrolyte inlets 28 may be used during the additional injection.

The sealing operation 117 is a process of sealing the electrolyte inlets 28. The electrolyte inlets 28 may be sealed by welding. The sealing operation 117 may be performed by welding using a laser welder 71 (see FIG. 8F) after inserting a stopper member for blocking the electrolyte inlet into the electrolyte inlets. By sealing the electrolyte inlets 28 through the sealing operation 117, the manufacture of the secondary battery 30 is completed.

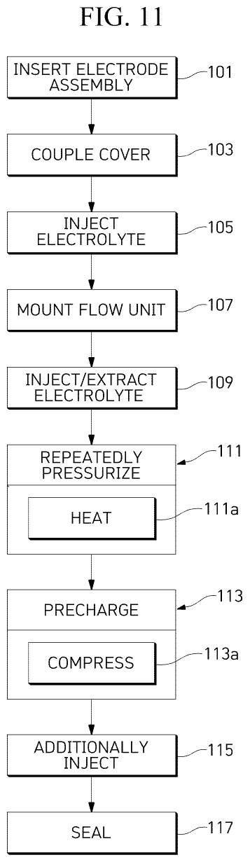

FIG. 11 is a flowchart for describing a modified example of the method of manufacturing a secondary battery according to an embodiment of the present disclosure.

As shown in FIG. 11, a heating process 111a may be added during the repeated pressurization operation 111. The heating process 111a is a process of heating the housing 23 while the repeated pressurization operation is performed. As the housing is heated, a viscosity of the electrolyte may temporarily decrease to increased kinetic energy and smoother circulation and coating of the electrolyte may be possible.

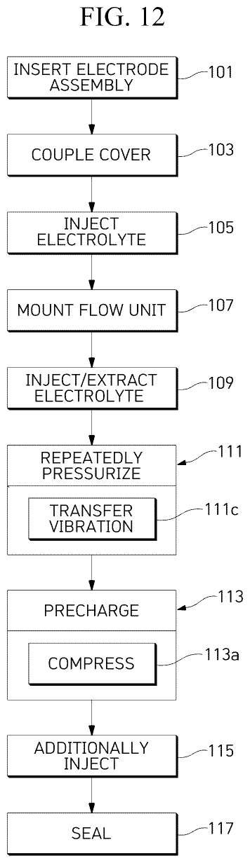

FIG. 12 is a flowchart illustrating another modified example of the method of manufacturing a secondary battery according to an embodiment of the present disclosure.

As shown in the drawing, a vibration transfer process 111c may be performed while the repeated pressurization operation 111 is performed. The vibration transfer process 111c is a process of applying minute vibration energy to the housing while the repeated pressurization operation 111 is performed. When a vibration is applied to housing 23, the electrolyte passing through electrode assembly 10 may have smooth flow characteristics without retention.

FIG. 13 is a diagram separately illustrating an electrolyte flow unit 40 of the apparatus for manufacturing a secondary battery according to an embodiment of the present disclosure.

As described above, while the electrolyte flow unit 40 is connected to the housing 23 of the secondary battery in which the electrode assembly 10 and the electrolyte are accommodated, the electrolyte flow unit 40 may discharge an electrolyte to the outside of the housing and guide the discharged electrolyte back into the housing.

The electrolyte flow unit 40 may include a pumping module 41, the first tube 43, and the second tube 44. The pumping module 41 is a case that allows the electrolyte to pass through the inside of the pumping module 41 and may accommodate the pump 41a, the pressure sensor 41c, the flow rate sensor 41e, and an input/output part 41g.

The pump 41a is installed in an electrolyte flow path and pumps the electrolyte. Circulation movement of the electrolyte may be performed by the pump 41a. The pump 41a may be operated by a control signal input through the input/output part 41g. The pressure sensor 41c may detect a flow pressure of the pumped electrolyte. The pressure information detected by the pressure sensor 41c may be output (e.g., as a signal) to an external component through the input/output part 41g.

In addition, the flow rate sensor 41e may detect a passing flow rate of the electrolyte pumped by the pump 41a for a set time. On the basis of the flow rate information detected by the flow rate sensor 41e, it is possible to determine approximately how many times the electrolyte circulates (e.g., has circulated) along the circulation path. For example, when the injected electrolyte is 10 cc and the total detected flow rate is 100 cc, it may be roughly estimated that the electrolyte circulates 10 times or less. On the basis of the determination result, an electrolyte circulation time may be determined.

The input/output part 41g may be a component configured to output the detected results of the pressure sensor 41c and the flow rate sensor 41e and input a signal for operating the pump 41a. For example, an on/off switch configured to operate the pump 41a may be included in the input/output part. In addition, the detected information of the pressure sensor 41c and the flow rate sensor 41e may be visually displayed on the input/output part 41g. Through other examples, the detected information may be transmitted to a smartphone or computer of an administrator in a wireless manner.

The first tube 43 and the second tube 44 may be connected to the electrolyte inlets provided in the housing 23. The first and second tubes 43 and 44 may be transparent plastic tubes with flexibility.

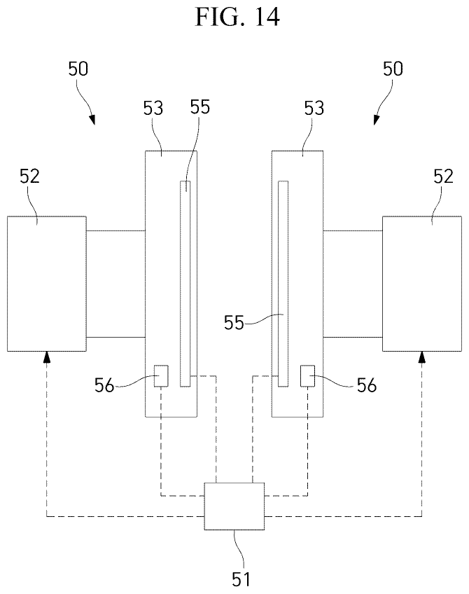

FIGS. 14 to 16 are diagrams for describing various types of modified examples of the pressurization unit of the apparatus for manufacturing a secondary battery according to embodiment(s) of the present disclosure.

Meanwhile, while the electrolyte flows by the electrolyte flow unit 40, the pressurization unit 50 may repeatedly pressurize the housing 23 to allow the electrode assembly within the housing to repeat compression and restoration. Two pressurization units 50 may constitute a single set. The two pressurization units 50 may have the same configuration.

The pressurization unit 50 may include a pressurization body 53 and a pushing module 52. The pressurization body 53 is a metal plate-shaped member with a predetermined thickness and may have a flat surface to come into surface contact with an outer surface of the housing 23. The total area of the pressurization body 53 facing the housing is greater than or equal to an area of the housing. That is, the area of the pressurization body 53 is at least greater than or equal to the surface contact area when the pressurization body 53 comes into surface contact with the housing.

The pushing module 52 may repeatedly pressurize the pressurization body 53 toward the housing 23. The pushing module 52 may be an electronic actuator. A pressurizing force with which the pushing module 52 pressurizes the pressurization body 53 may be adjustable.

In addition, as shown in FIG. 14, a heating part 55 and a temperature sensor 56 may be installed in the pressurization body 53. The heating part 55 may heat the pressurization body 53 by outputting heat due to power applied through a temperature controller 51. As described above, heating the pressurization body 53 may provide heat to the housing 23. A heating temperature of the heating part 55 is controllable by the temperature controller 51.

The temperature sensor 56 detects a temperature of the pressurization body 53 and transmits the detected temperature information (e.g., as a signal) to the temperature controller 51. The temperature controller 51 may control an output temperature of the heating part 55 on the basis of the received temperature information.

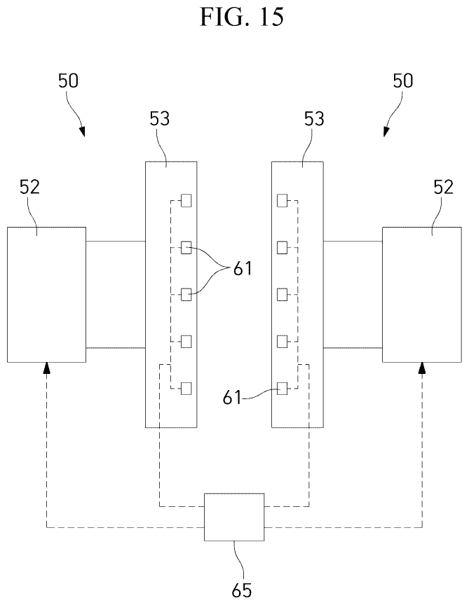

In addition, as shown in FIG. 15, vibration generators 61 may be installed in the pressurization body 53. The vibration generators 61 may apply vibration energy to the pressurization body 53. When the vibration generators 61 operate, the pressurization body 53 may vibrate slightly to prevent retention of the electrolyte passing through the electrode assembly 10. An operation of the vibration generators 61 may be controlled by a vibration controller 65. The vibration controller 65 may turn the vibration generators 61 on and off and control a vibration pattern and a magnitude of the vibration energy.

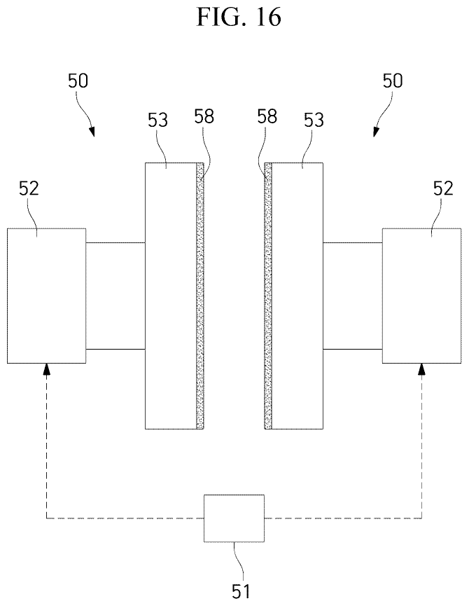

In addition, as shown in FIG. 16, a cover plate 58 may be additionally mounted on an opposite surface of the pressurization body 53, i.e., a surface facing the housing 23. The cover plate 58 is a plate-shaped member with a predetermined thickness and prevents damage to the housing 23. The cover plate 58 may be made of a synthetic resin or engineering plastic.

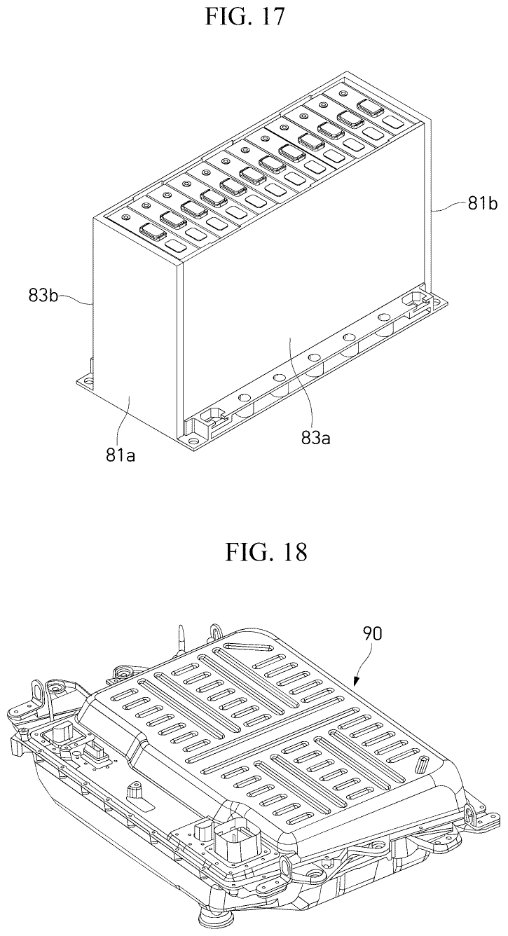

FIG. 17 is an perspective view of a secondary battery module in which secondary batteries are arranged according to embodiments of the present disclosure. With the increase in secondary battery capacity for driving electric vehicles or the like, a secondary battery module may be manufactured by arranging a plurality of secondary battery cells transversely and/or longitudinally and connecting (e.g., electrically) them together. The plurality of secondary batteries may be arranged in a space defined by a pair of facing end plates 81a and 81b and a pair of facing side plates 83a and 83b. The secondary batteries may be arranged in an arrangement (direction) and number to obtain desired voltage and current specifications.

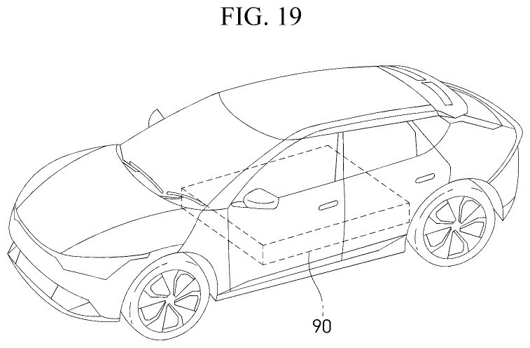

FIG. 18 is a perspective view of a battery pack 90 according to embodiments of the present disclosure. Referring to FIG. 18, the battery pack 90 may include an assembly to which individual batteries are electrically connected and a pack housing accommodating the same. In the drawings, for convenience of illustration, components including a bus bar, a cooling unit, external terminals for electrically connecting batteries, etc., are omitted.

The battery pack 90 may be mounted on (or in) a vehicle. The vehicle may be, for example, an electric vehicle, a hybrid vehicle, or a plug-in hybrid vehicle. The vehicle may be a four-wheeled vehicle or a two-wheeled vehicle, but a different number of wheels is possible. FIG. 19 shows a vehicle that includes the battery pack 90 shown in FIG. 18 on the lower body thereof. The vehicle may operate by (e.g., may be powered by) receiving power from the battery pack 90.

When a secondary battery is manufactured, a process is carried out in which an electrode assembly is accommodated in a battery can, the electrode assembly and an external terminal are electrically connected, an electrolyte is injected, and subsequently the electrode assembly is precharged. In this process, there occurs a problem of a local charging malfunction due to lifting or insufficient bonding of electrode plates constituting the electrode assembly immersed in the electrolyte and side reactions due to the local charging malfunction. In addition, since a thickness of the electrode assembly may increase, there may be a limitation to an energy density capable of being obtained within a given battery can space.

The present disclosure is directed to providing an apparatus and method for manufacturing a secondary battery that allows an electrolyte injected into a battery can to flow to and enter an interior of an electrode assembly, while simultaneously inducing a negative pressure action on the electrode assembly to increase efficiency of electrolyte impregnation into the electrode assembly.

According to an apparatus and method for manufacturing a secondary battery, an electrolyte injected into a battery can passes through an electrode assembly through circulation movement and percolates into the inside of the electrode assembly, and simultaneously, by repeatedly applying a pressure to the electrode assembly, a negative pressure action is induced, and thus efficiency of electrolyte impregnation is increased with respect to the electrode assembly so that a good solid electrolyte interface (SEI) layer can be formed on an electrode plate.

Although the present disclosure has been described above with respect to embodiments thereof, the present disclosure is not limited thereto. Various modifications and variations can be made thereto by those skilled in the art within the spirit of the present disclosure as defined by the appended claims and their equivalents.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method of manufacturing a secondary battery, the method comprising:
initially injecting an electrolyte into an internal space of a housing in which an electrode assembly is accommodated;
extracting the electrolyte initially injected into the internal space of the housing to an outside of the housing;
reinjecting the electrolyte into the internal space of the housing; and
applying power to the electrode assembly to charge the electrode assembly after reinjecting the electrolyte.

2. The method as claimed in claim 1, wherein:
the housing is elastically deformable, and
the method further comprises, while reinjecting the electrolyte, repeatedly pressurizing the housing to allow the electrode assembly inside the housing to be repeatedly compressed and restored.

3. The method as claimed in claim 2, wherein the initially injecting includes injecting a portion of a maximum volume of the electrolyte, the method further comprising, after applying power to the electrode assembly, additionally injecting the electrolyte into the housing.

4. The method as claimed in claim 2, further comprising applying heat to the housing while repeatedly pressurizing the housing.

5. The method as claimed in claim 4, wherein a vibration transfer process of applying a vibration to the housing is performed while the repeatedly pressurizing operation is performed.

6. The method as claimed in claim 1, further comprising, after applying power to the electrode assembly, injecting the electrolyte into the housing.

7. The method as claimed in claim 1, further comprising, after initially injecting the electrolyte, connecting a flow unit configured to inject the electrolyte into the housing and extract the electrolyte from the housing.

8. The method as claimed in claim 7, wherein:
the flow unit comprises:
a pumping module in which a pump is embedded,
a first tube connected to a first side of the pumping module, and
a second tube connected to a second side of the pumping module, the first tube and the second tube being connected to the housing, and
initially injecting the electrolyte includes operating the pump so that the electrolyte inside the housing passes through the first tube, the pump, and the second tube and returns to the housing.

9. An apparatus for manufacturing a secondary battery, the apparatus comprising:
a flow unit configured to discharge an electrolyte to an outside of a housing, resulting in a discharged electrolyte, and guide the discharged electrolyte back into the housing while connected to the housing of the secondary battery in which an electrode assembly and the electrolyte are accommodated, wherein the flow unit comprises a pumping module in which a pump is embedded;
a first tube connected to a first side of the pumping module; and
a second tube connected to a second side of the pumping module and connected to the housing to discharge the electrolyte.

10. The apparatus as claimed in claim 9, wherein:
the housing includes a first electrolyte inlet and a second electrolyte inlet; and
the first tube is connected to the first electrolyte inlet, and the second tube is connected to the second electrolyte inlet.

11. The apparatus as claimed in claim 9, wherein the pumping module comprises:
a pressure sensor configured to detect a pressure of the electrolyte introduced into the housing; and
a flow rate sensor configured to detect a flow rate of a pumped electrolyte.

12. The apparatus as claimed in claim 11, wherein the pumping module further comprises an input/output part configured to output detected results of the pressure sensor and the flow rate sensor.

13. The apparatus as claimed in claim 9, wherein:
the housing is elastically deformable; and
the apparatus further comprises a plurality of pressurization units configured to repeatedly pressurize the housing while the electrolyte flows by the flow unit to allow the electrode assembly within the housing to be repeatedly compressed and restored.

14. The apparatus as claimed in claim 13, wherein each of the plurality of pressurization units includes a pressurization body configured to come into surface contact with the housing and push modules configured to repeatedly pressurize each pressurization body toward the housing.

15. The apparatus as claimed in claim 14, wherein a plurality of the pressurization body includes two pressurization bodies, the two pressurization bodies being on opposite sides of the housing.

16. The apparatus as claimed in claim 15, wherein a total area of the two pressurization bodies facing the housing is greater than or equal to a close contact area between the two pressurization bodies and the housing.

17. The apparatus as claimed in claim 16, wherein cover plates are mounted on opposite surfaces of the two pressurization bodies.

18. The apparatus as claimed in claim 16, wherein a heating part configured to heat the two pressurization bodies is in each of the two pressurization bodies.

19. The apparatus as claimed in claim 18, further comprising a temperature controller configured to control a heating temperature of each heating part.

20. The apparatus as claimed in claim 14, wherein a vibration generator configured to apply vibration energy to each pressurization body is further installed in each pressurization body.
